(19) United States
(12) Patent Application Publication
(10) Pub. No.: US 2014/0359350 A1
(43) Pub. Date: Dec. 4, 2014

(54) WEAR-LEVELING CORES OF A MULTI-CORE PROCESSOR

(71) Applicants: Jeffrey A PLANK, Cypress, TX (US); Robert E. VAN CLEVE, Houston, TX (US)

(72) Inventors: Jeffrey A PLANK, Cypress, TX (US); Robert E. VAN CLEVE, Houston, TX (US)

(21) Appl. No.: 14/366,927

(22) PCT Filed: Feb. 24, 2012
(86) PCT No.: PCT/US2012/026485

§ 371 Date: Jun. 19, 2014

(51) Int. Cl. G06F 11/20; G06F 11/07

(52) U.S. Cl. CPC G06F 11/2097; G06F 11/2041; G06F 11/0724; G06F 2201/82
USPC 714/10

(57) ABSTRACT

Techniques that relate to wear-leveling cores of a multi-core processor are described in various implementations. The techniques may include determining, for a plurality of cores of a multi-core processor, usage information that is indicative of past wear on the plurality of cores. The techniques may also include selectively activating a subset of the plurality of cores based on the usage information such that cores that exhibit less wear relative to other cores are preferentially selected for activation.

### BACKGROUND

Many modern computing devices include multi-core processors that may, in some cases, provide increased processing performance over a traditional single-core processor. A multi-core processor includes two or more independent processors, or “cores”, that are typically integrated onto a single chip. Multi-core processors may be particularly well-suited for use in multitasking environments or other types of environments where multiple operations can be processed in parallel.

Overclocking a processor, whether single-core or multi-core, may improve the processing performance of the processor. For example, overclocking may allow the processor to operate at a higher frequency than specified by the processor manufacturer, and therefore to perform more operating cycles in a given period of time. In some cases, overclocking may cause the processor to become unstable, which can sometimes be corrected by increasing the operating voltage applied to the processor. In general, higher operating voltages also lead to higher processor operating temperatures.

The potential benefits of overclocking a processor to achieve improved performance may involve a tradeoff in the form of diminished useful life of the processor. For example, while the useful life of some processors may typically be measured in the range of seven to ten years, aggressively overclocking the same processors may reduce their useful life to a year or even a few months.

### BRIEF DESCRIPTION OF THE DRAWINGS

FIG. 1 shows a block diagram of a computing device with a controller for activating cores of a multi-core processor.

FIG. 2 shows an example flow diagram of a process for wear-leveling cores of a multi-core processor.

FIG. 3 shows an example flow diagram of a process for activating a desired number of cores of a multi-core processor.

### DETAILED DESCRIPTION

The performance improvement that can be gained using a multi-core processor is often dependent on the capabilities and/or configuration of the operating system and application software that is executing on the multi-core processor. For example, certain operating systems or applications may only be capable of utilizing a certain number of cores simultaneously, which may be less than the number of available cores in the multi-core processor. As another example, the operating system and software applications may be capable of utilizing all of the cores of a multi-core processor, but may be configured to utilize less than all of the cores, e.g., upon explicit instruction from an administrator. Such configurations may be used, for example, to reduce the amount of power consumed or the amount of heat generated by the multi-core processor.

In any given operating session, or any given portion of an operating session, a computing device with an N core processor may be configured to utilize a certain number of the N available cores. For example, the computing device may be configured to utilize all N of the cores, or some subset of the N cores. If it is known how many of the cores will be utilized, the computing device may activate the desired number of cores, while deactivating any remaining cores.

In cases where only a subset of the cores is to be activated it may be beneficial to wear-level the cores of the multi-core processor by selectively activating different ones of the cores over time so that one or more of the cores are not over-activated or otherwise overused in relation to the other cores. For example, in a computing device with an eight core processor, where only two of the eight cores are being utilized in a typical operating session, different ones of the eight cores may be activated during different operating sessions, or even during the course of a single operating session, such that each of the eight cores is exposed to a similar level of wear or fatigue as the other cores.

In some implementations, the cores of a multi-core processor may be wear-leveled by determining usage information that is indicative of past wear on the cores, and selectively activating a subset of the plurality of cores based on the usage information such that cores that exhibit less wear relative to other cores are preferentially selected for activation over the other cores. The selective activation of certain of the cores may take place at boot time, e.g., by utilizing an available bitmask for core enablement by the BIOS, or may take place during runtime, e.g., through the use of C-State settings on a per core basis. In some cases, cores that have been determined to be exhausted may be excluded from the pool of cores that are available for the selective activation.

The usage information to be considered in selectively activating the cores may include, for example, core operation time, operating voltage, operating temperature, and/or error information such as errors or error rates associated with a particular core. The usage information may also include other appropriate performance or operational metrics, including, for example, runtime hours weighted by temperature bands and/or voltage applied, or least error rate counters, or the like.

In some cases, the usage information may indicate similar wear patterns for cores that have been used in a consistent manner, such as in non-overclocked conditions where the processor cores have generally been operated at the same or similar operating voltages and temperatures. In these cases, the primary parameter affecting the wear on a core may be the amount of time it has been operated. In such cases, cores that have been operated for relatively fewer hours may be selected for activation over cores that have been operated for relatively more hours, assuming all other operational parameters being relatively equal.

In other cases, such as where the user has overclocked the processor during certain operating sessions or has otherwise used the cores in an inconsistent manner, the usage information may indicate varying wear patterns based on how the cores were actually operated during previous sessions (e.g., time-weighted average voltage applied to the core, or time-weighted average temperature of the core, during the amount of time that the core has been operated). In these cases, cores that are determined to be “fresher” may not always be the cores that have been operated the fewest number of hours. Instead, the amount of wear on the cores may be estimated based on a plurality of operational parameters that generally describe how hard the core has been driven during past operating sessions.

The techniques described here may be used to extend the useful life of the cores of a multi-core processor, such as a multi-core processor that has been overclocked to achieve improved performance. Other possible benefits and advantages will be apparent from the figures and from the description that follows.

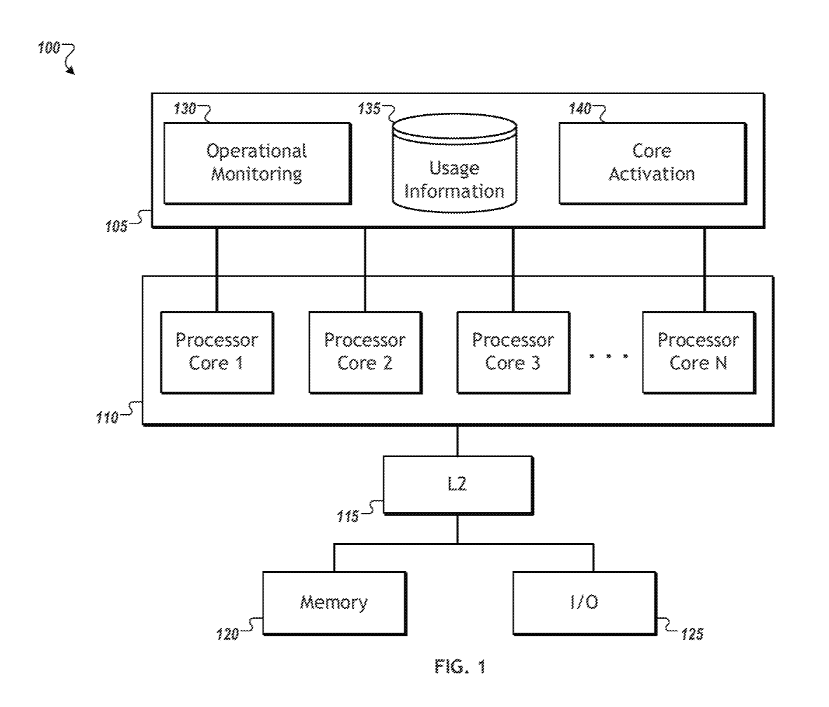

FIG. 1 shows a block diagram of a computing device 100 with a controller 105 for activating cores of a multi-core processor 110. Computing device 100 may represent any appropriate computing device or system having a multi-core processor. Various examples of computing device 100 may include, for example, a laptop, desktop, workstation, smartphone, personal digital assistant, server, blade server, or the like. The example configuration of computing device 100 is shown for illustrative purposes only, and it should be understood that various modifications may be made to the configuration. For example, computing device 100 may include different or additional components, or the components may be connected in a different manner than is shown.

Computing device 100 includes a multi-core processor 110 having N cores, where N is any appropriate integer. For example, multi-core processor 110 may include two cores, four cores, eight cores, sixteen cores, or another appropriate number of cores. In some implementations, multi-core processor 110 may be configured as a homogeneous multi-core processor, with all of the cores being more or less identical to one another. In other implementations, multi-core processor 110 may be configured as a heterogeneous multi-core processor, with two or more diverse processor cores. In a heterogeneous multi-core processor configuration, the various cores may provide similar or different resources, and the cores may demonstrate similar or different performance and efficiency characteristics.

Each of the cores of multi-core processor 110 may have a corresponding first level (L1) instruction cache (not shown) and corresponding data cache (not shown). The cores of multi-core processor 110 may all share a common second level (L2) cache 115, a main memory 120, and an input/output (I/O) interface 125. Operating system and application software may be stored in, and may execute from, main memory 120, and instructions may be cached through the respective L2 and L1 caches to the processor cores.

Computing device 100 may be configured to execute an operating system and application software using all or fewer than all of the cores of the multi-core processor 110. For example, in some cases, the operating system and/or the application software may be configured to utilize all of the cores in multi-core processor 110 during a given operating session. In such cases, computing device 100 may activate all of the cores, e.g., during boot or during operation, such that all of the cores are available to process instructions.

In other cases, the operating system and/or the application software may be configured to utilize fewer than all of the cores in multi-core processor 110, or may otherwise be programmed to limit the number of active cores, e.g., based on instructions from an administrator of the device. In such cases, controller 105 may cause a subset of the cores to be activated in a manner that levels the wear on the various cores over time. Such activation of the subset of cores may take place upon boot of the computing device 100 (e.g., by utilizing an available bitmask for core enablement by the BIOS), or may take place during runtime (e.g., through the use of C-State settings on a per core basis).

Controller 105 may include appropriate components for monitoring the usage of the cores of multi-core processor 110, and for selectively activating one or more of the cores based on the gathered usage information. For example, as shown, controller 105 includes an operational monitoring unit 130, a usage information data store 135, and a core activation unit 140. It should be understood that these components are shown for illustrative purposes only, and that in some cases, the functionality being described with respect to a particular component may be performed by one or more different or additional components. Similarly, it should be understood that portions or all of the functionality may be combined into fewer components than are shown.

One or more of the cores of multi-core processor 110 may be configured to process instructions for execution by the controller 105. The instructions may be stored on a tangible computer-readable storage medium, such as in main memory 120 or on a separate storage device (not shown), or on any other type of volatile or non-volatile memory that stores instructions to cause a programmable processor to perform the techniques described herein. Alternatively or additionally, controller 105 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Operational monitoring unit 130 may be configured to monitor various operational parameters associated with the cores of multi-core processor 110, and to store operational information associated with each of the cores, e.g., in usage information data store 135. Such monitoring and storing may occur continuously or periodically, and may also or alternatively be triggered by various events associated with computing device 100 (e.g., upon initiation of shutdown procedures, upon boot, upon a change in the number of desired active processors for a particular operating session, or the like). The types of operational information that are monitored and stored may depend on the particular implementation, and on the performance or operational characteristics that are deemed to be relevant to the particular implementation. For example, a few of the operational parameters that may be relevant in the context of wear-leveling an overclocked multi-core processor are described in greater detail below, but it should be understood that the techniques described here may also be applied using other or additional parameters, either in the overclocking context or in other contexts.

In some implementations, operational monitoring unit 130 may monitor runtime hours for each of the various cores of multi-core processor 110. For example, for every operating session in which a particular core has been activated for use, operational monitoring unit 130 may store data that reflects how long the core was operated during the session. In operating sessions where the cores were activated for the entire session, the data may simply reflect the length of the operating session and which of the various cores were activated for the session. In operating sessions where different cores were activated and/or deactivated during the course of the session, the data may reflect the length of time that each of the various cores were activated during the session. Such runtime information may be stored individually by session (e,g., runtime hours per session), in the aggregate (e.g., runtime hours for the life of the core), or both.

Operational monitoring unit 130 may also monitor and store certain operational parameters that correspond to the manner in which the cores were operated. For example, the amount of time that a particular core has been operated may provide some indication as to the amount of wear on the core, but a core that has been overclocked may exhibit different wear patterns (e.g., relatively more wear) than a core that has not been overclocked (e.g., relatively less wear), even if the cores have been activated for similar lengths of time. Different overclocking scenarios may also vary greatly from one another, with minimal or moderate overclocking only leading to a slightly increased wear pattern compared to normal operating conditions, while more aggressive overclocking may lead to much higher wear on the cores as compared to normal operating conditions.

In some implementations, operational monitoring unit 130 may monitor and store the runtime hours of the various cores weighted by the operating voltage that was applied to the core during the time that the core was operated. In some overclocking scenarios, the higher the frequency at which the processor is overclocked, the higher the operating voltage may be raised to maintain stability of the processor. In turn, cores that have been operated at relatively higher operating voltages may exhibit more wear than cores that have been operated at relatively lower operating voltages. Such operating voltage information may be stored individually by session (e.g., runtime hours for the session at an average operating voltage applied to the core for the session), in the aggregate (e.g., runtime hours for the life of the core at a time-weighted average voltage applied to the core for the life of the core), or both.

Similarly, operational monitoring unit 130 may monitor and store the runtime hours of the various cores weighted by the temperature of the core during the time that the core was operated. As with core runtime and operating voltages, the temperature information may be stored individually by session (e.g., runtime hours for the session at an average temperature of the core for the session), in the aggregate (e.g., runtime hours for the life of the core at a time-weighted average temperature of the core for the life of the core), or both.

In some implementations, the temperature metrics may be stored, for example, as temperature bands that represent different relative levels of wear on the cores. For example, a core temperature of between thirty-five and fifty degrees Celsius may be classified as belonging to a first temperature band that corresponds to normal operating conditions, a core temperature between fifty and seventy degrees Celsius may be classified as belonging to a second temperature band that corresponds to slightly elevated wear compared to normal operating conditions, and a core temperature of seventy degrees Celsius or above may be classified as belonging to a third temperature band that corresponds to greatly elevated wear compared to normal operating conditions. It should be understood that these specific temperature ranges and temperature band classifications are provided for illustrative purposes only, and that other appropriate temperature ranges and/or classifications may be used in a particular implementation.

Operational monitoring unit 130 may also track error information associated with the various cores of multi-core processor 110. For example, during operation of computing device 100, error events may occur and be recorded in an error log. The error log may include information that associates the error with the particular core that encountered the error. While certain numbers of errors and/or error rates may be acceptable, higher rates of errors may be indicative of a processor that has become unstable. As described above, such instability may be associated with aggressive overclocking. In some cases, a core may be incapable of a certain level of overclocking regardless of previous usage, and may exhibit unacceptable errors or error rates when such overclocking is attempted. In these cases, the usage information that is considered when the cores are selectively activated may include the error information, and the core may effectively be removed from the pool of available cores for activation. As with the other operational parameters described above, such error information may be stored on a per session basis, in the aggregate, both.

The monitored usage metrics described above, and any other appropriate usage metrics that may be indicative of the wear on a core, may be stored in usage information data store 135. Usage information data store 135 may represent any appropriate storage mechanism, including for example, a local non-volatile memory that is accessible by core activation unit 140. In some implementations, usage information data store 135 may maintain a data structure that represents the various monitored metrics for each of the cores. The data structure may include usage metrics that have been collected and stored on a per session basis, or usage metrics that have been aggregated over time, or both. In some implementations, the data structure may be organized as a two-dimensional array of elements, where the x-axis represents a core identifier for each of the cores of the multi-core processor 110, and the y-axis represents a set of usage metrics and/or calculated values that may be used for comparative purposes during core selection.

Core activation unit 140 may be configured to access the data stored in usage information data store 135, and to intelligently determine a subset of the cores of the multi-core processor 110 to activate based on the usage information associated with each of the cores. The usage information may include per session or aggregated usage metrics that are indicative of how a particular core has been used in the past, and may therefore allow the core activation unit 140 to selectively activate the “fresher” cores for subsequent operating sessions in a manner that wear-levels the cores over time.

Core activation unit 140 may be configured to perform the selective core activation techniques at system startup or to perform reconfiguration of the active and inactive cores during operation. In the case of reconfiguration during operation, core activation unit 140 may perform the techniques described here at any number of appropriate times. For example, core reconfiguration may take place periodically (e.g., every three hours of operation), or based on a schedule (e.g., a user-defined timetable), or in response to a threshold of use being reached for one or more of the operational parameters (e.g., when an error rate threshold has been exceeded).

In use, core activation unit 140 may first identify how many cores are to be activated during a particular operating session or during a particular portion of an operating session. If all of the cores in multi-core processor 110 are to be activated, then core activation unit 140 may simply activate all of the cores without analyzing the past usage information. On the other hand, if fewer than all of the cores in multi-core processor 110 are to be activated, core activation unit 140 may cause a subset of the cores to be activated in a manner that levels the wear on the various cores over time.

To wear-level the cores of the multi-core processor 110, the core activation unit may analyze one or more of the stored past usage metrics to determine the amount of wear exhibited by each of the cores, and may selectively activate the subset of cores that exhibit the least amount of wear relative to the other cores. The specific algorithm or algorithms for determining the amount of wear exhibited by a core may be configurable, and may be based, for example, on empirical or theoretical wear patterns. In some implementations, such algorithms may be used to estimate the amount of wear on a particular core, e.g., by calculating a wear score that corresponds to how much stress has been placed on the core over time.

For example, in a dual-core processor, a first core may have previously been operated for one hundred hours at a time-weighted average temperature of fifty degrees Celsius, while a second core may have been operated for twenty-five hours at a time-weighted average temperature of eighty degrees Celsius. One simple example of a wear estimation model may be to multiply the runtime hours by a temperature coefficient to determine a wear score for each of the cores. The temperature coefficient may be based on the average core operating temperature, where a temperature of fifty degrees corresponds to a coefficient of one (e.g., fifty degrees is considered a “normal” operating temperature that does not cause additional stress to the core), and a temperature of eighty degrees corresponds to a coefficient of eight (e.g., operating the core at eighty degrees causes eight times the amount of stress as operating the core at a “normal” temperature). In such a scenario, the core activation unit 140 may consider the first core to be “fresher” than the second core, because the wear score for the first core is one hundred (one hundred hours multiplied by a temperature coefficient of one) while the wear score for the second core is two hundred (twenty five hours multiplied, by a temperature coefficient of eight).

In such a scenario, during a next activation period for which only one of the two cores is to be activated, the core activation unit 140 will cause the first core to be activated, even though the first core has been operated for a greater amount of time than the second core. During that particular operating session, operational monitoring unit 130 will monitor and store additional usage metrics in usage information data store 135, and such information will be considered by core activation unit 140 the next time activation of a subset of the cores is desired. For example, if the first core is operated for another ten hours at a temperature of ninety degrees Celsius, then the first core may have a wear score above two hundred, and the second core may then be the “fresher” of the two cores, such that the second core will be activated during the next activation period.

It should be understood that the relatively simple wear score algorithm described above is for explanatory purposes only, and that other appropriate wear score algorithms, which may be based on additional usage metrics or combinations of usage metrics, may additionally or alternatively be used.

In some implementations, related but different algorithms may be used to estimate the projected lifespan of a core (e.g., the remaining useful life of the core as opposed to a wear score associated with how hard the core has been driven). Similar to the wear score algorithms, the projected lifespan algorithms may also be based on one or more core usage metrics that have been gathered over time. While such projected lifespan algorithms may in some cases be designed to correspond directly to the wear score algorithm described above (e.g., typical lifespan minus the estimated wear on a core equals the remaining useful life of the core), different estimation models or other considerations may cause the algorithms to reach different results. In such cases where different estimation models are considered for the wear score versus the projected lifespan, the two algorithms may be combined in an appropriate manner to achieve an estimation model that may be more accurate than either of the estimation models on their own.

While the examples above have described comparing all of the various cores in multi-core processor 110 to determine the “freshest” cores for activation, some implementations may exclude one or more of the cores from the pool of available cores if the core is determined to be exhausted. As with the wear score and projected lifespan algorithms described above, core exhaustion may be defined differently in different implementations. For example, a core may be considered to be exhausted if the error rates associated with the core exceed a particular threshold over a particular period of time. As another example, a core may be considered to be exhausted if it reaches a wear score above a user-definable threshold. In yet another example, a core may be considered to be exhausted when the projected lifespan of the core falls below a user-definable threshold. In any case, regardless of how core exhaustion is defined, the cores that have been marked as exhausted in usage information data store 135 may be excluded from the pool of available cores that are considered for activation using the core activation techniques described here.

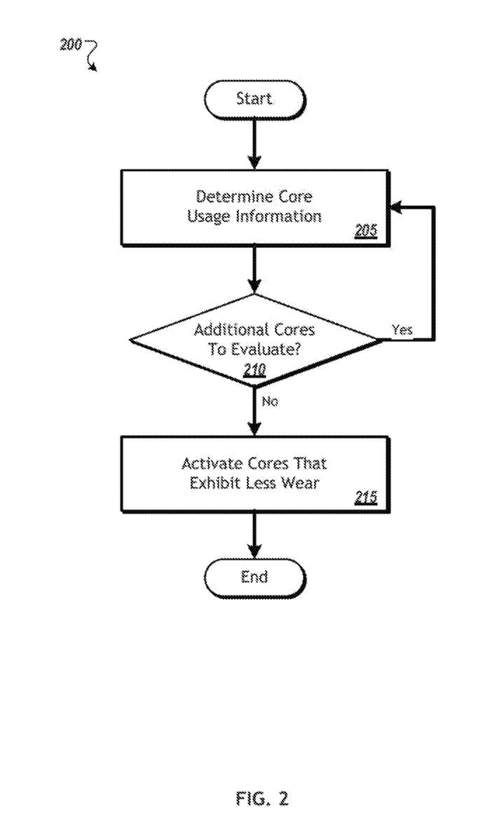

FIG. 2 shows an example flow diagram of a process 200 for wear-leveling cores of a multi-core processor. The process 200 may be performed, for example, by a controller such as the controller 105 illustrated in FIG. 1. For clarity of presentation, the description that follows uses the controller 105 illustrated in FIG. 1 as the basis of an example for describing the process. However, it should be understood that another system, or combination of systems, may be used to perform the process or various portions of the process.

Process 200 begins at block 205, in which core usage information is determined for a particular core. For example, core activation unit 140 of controller 105 may query core usage information data store 135 to identify one or more usage metrics that are indicative of past wear on the core. The usage metrics may include, for example, runtime hours, error rates, operating temperatures, operating voltages, and/or other appropriate metrics that are considered by the implementation-specific wear models to have an objective effect on the wear exhibited by the processor cores.

In some implementations, the objective effect that the various observed usage metrics have on the cores may be quantified, and a numerical fatigue or wear score may be calculated according to an implementation-specific algorithm. The wear score corresponds to an estimation of how much wear has been put on the core over the life of the core, and may be used to rank the “freshness” of the particular core against other cores. For example, a core that receives a wear score of seventy-five may be considered “fresher” than a core that receives a wear score of two hundred.

At decision block 210, it is determined whether any additional cores should be evaluated. If so, process 200 continues at block 205, where the core usage information and corresponding wear score for another of the cores is determined. Block 205 may be repeated, e.g., until all of the non-exhausted cores of the multi-core processor have been evaluated. In some implementations, the wear score for a core that has been marked as exhausted may be set to a maximum wear score value, such that the exhausted core can never be considered “fresher” than any of the other non-exhausted cores.

At block 215, the core activation unit 140 may cause the desired number of cores to be activated in increasing order of the wear exhibited by each of the cores (e.g., such that cores that exhibit less wear relative to other cores are preferentially selected for activation over the other cores). For example, the cores may be selected for activation in order of ascending wear scores, with cores having lower wear scores being activated before cores having higher wear scores. Such selective activation may ensure that the cores are wear-leveled over time.

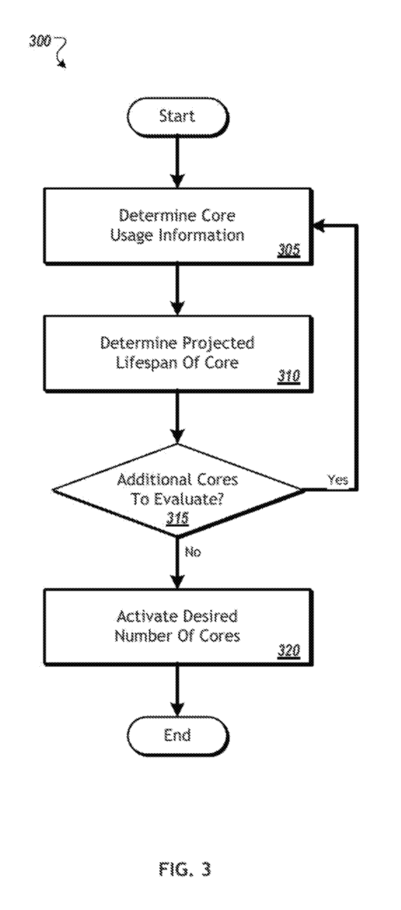

FIG. 3 shows an example flow diagram of a process 300 for activating a desired number of cores of a multi-core processor. The process 300 may be performed, for example, by a controller such as the controller 105 illustrated in FIG. 1. For clarity of presentation, the description that follows uses the controller 105 illustrated in FIG. 1 as the basis of an example for describing the process. However, it should be understood that another system, or combination of systems, may be used to perform the process or various portions of the process.

Process 300 begins at block 305, in which core usage information is determined for a particular core. For example, core activation unit 140 of controller 105 may query core usage information data store 135 to identify one or more usage metrics that are indicative of the remaining useful life of the core. The usage metrics may include, for example, runtime hours, error rates, operating temperatures, operating voltages, and/or other appropriate metrics that are considered by the implementation-specific projected lifespan models to have an objective effect on the estimated remaining useful life of the processor cores.

At block 310, the projected lifespan of the core is determined based on the usage information. For example, the objective effect that the various observed usage metrics have on the remaining useful life of the core may be quantified, and a projected lifespan for the core may be calculated according to an implementation-specific algorithm. The projected lifespan for the cores may be used to rank the “freshness” of the particular core against other cores. For example, a core that has a longer projected lifespan than another core may be considered “fresher” than the other core.

At decision block 315, it is determined whether any additional cores should be evaluated. If so, process 300 continues at blocks 305 and 310, where the core usage information and corresponding projected lifespan for another of the cores is determined. Blocks 305 and 310 may be repeated, e.g., until all of the non-exhausted cores of the multi-core processor have been evaluated. In some implementations, the projected lifespan of a core that has been marked as exhausted may be set to zero, such that the exhausted core can never be considered “fresher” than any of the other non-exhausted cores.

At block 320, the core activation unit 140 may cause the desired number of cores to be activated in decreasing order of the projected lifespans associated with each of the cores (e.g., such that cores that have a longer projected lifespan relative to other cores are preferentially selected for activation before the other cores). Such selective activation may ensure that cores with relatively higher estimated remaining useful life are activated preferentially over cores with relatively lower estimated remaining useful life, which in turn serves to wear-level the cores over time.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is;:

1. A method for wear-leveling cores of a multi-core processor, the method comprising:
determining, for a plurality of cores of a multi-core processor of a computing device, usage information that is indicative of past wear on the plurality of cores; and
selectively activating, using the computing device, a subset of the plurality of cores based on the usage information such that cores that exhibit less wear relative to other cores are preferentially selected for activation.

2. The method of claim 1, wherein the usage information includes, for each of the plurality of cores, an amount of time that the core has been operated.

3. The method of claim 2, wherein the usage information further includes, for each of the plurality of cores, a time-weighted average voltage applied to the core during the amount of time that the core has been operated.

4. The method of claim 2, wherein the usage information further includes, for each of the plurality of cores, a time-weighted average temperature of the core during the amount of time that the core has been operated.

5. The method of claim 1, wherein the usage information includes, for each of the plurality of cores, error information that corresponds to errors or error rates associated with the core.

6. The method of claim 1, wherein exhausted cores are excluded from being activated.

7. A system comprising:
a computing device;
a processor of the computing device, the processor having a plurality of cores;
a memory accessible by the computing device to store usage information that corresponds to past usage parameters associated with the cores; and
an activation module executing on the computing device to determine a subset of the plurality of cores to activate based on the usage information.

8. The system of claim 7, wherein the usage information includes, for each of the plurality of cores, an amount of time that the core has been operated.

9. The system of claim 8, wherein the usage information further includes, for each of the plurality of cores, a time-weighted average voltage applied to the core during the amount of time that the core has been operated.

10. The system of claim 8, wherein the usage information further includes, for each of the plurality of cores, a time-weighted average temperature of the core during the amount of time that the core has been operated.

11. The system of claim 7, wherein the usage information includes, for each of the plurality of cores, error information that corresponds to errors or error rates associated with the core.

12. The system of claim 7, wherein the activation module excludes exhausted cores from being considered for activation.

13. A non-transitory computer-readable storage medium storing instructions that, when executed by a processor, cause the processor to:
determine, for each of a plurality of cores of a multi-core processor, usage information that is indicative of remaining useful life of the plurality of cores;
determine, for each of the plurality of cores, a projected lifespan of the core based on the usage information associated with each core; and
activate a desired number of cores in decreasing order of the projected lifespan of the cores.

14. The non-transitory computer-readable storage medium of claim 13, wherein the usage information includes, for each of the plurality of cores, an amount of time that the core has been operated.

15. The non-transitory computer-readable storage medium of claim 14, wherein the usage information further includes, for each of the plurality of cores, a time-weighted average voltage applied to the core during the amount of time that the core has been operated.

16. The non-transitory computer-readable storage medium of claim 14, wherein the usage information further includes, for each of the plurality of cores, a time-weighted average temperature of the core during the amount of time that the core has been operated.

17. The non-transitory computer-readable storage medium of claim 13, wherein the usage information includes, for each of the plurality of cores, error information that corresponds to errors or error rates associated with the core.

18. The non-transitory computer-readable storage medium of claim 13, wherein the projected lifespan of an exhausted core is set to zero such that the exhausted core is never activated.
